(19) United States
(12) Patent Application Publication
(10) Pub. No.: US 2006/0042153 A1
(43) Pub. Date: Mar. 2, 2006

(54) Animal trap

(76) Inventor: Stephen Henry Bowerman, Middlesex (GB)

Correspondence Address: Matthew J. Booth & Associates, PLLC, P O BOX 50010, AUSTIN, TX, 78763-0010, US

(21) Appl. No.: 10/469,480

(22) PCT Filed: Feb. 26, 2001
(86) PCT No.: PCT/GB01/00810

§ 371 Date: Apr. 1, 2004

(51) Int. Cl. A01M 23/18

(52) U.S. Cl. 43/61

(57) ABSTRACT

An animal trap (1) comprising a containment body (2) with at least two entrances, each entrance having a door (3) operable to close and contain an animal within the containment body, the entrances to the containment body being aligned so as to provide an animal to be trapped with a view through the containment body. There is also disclosed an animal trap system incorporating an animal trap having a transmitter unit (10) operable to transmit a first signal indicative of the presence of the trap.

relates to an animal trap and more particularly to a humane animal trap.

Animal traps are well known devices which may comprise a containment system, a closeable element and a trigger device operable to close the closeable element and secure an animal within the containment system. Poison or a device for killing the animal may also be included within the animal trap. Bait may be provided to entice the animal to go into or onto the trap.

Conventional animal traps have only a single entrance and therefore present an animal with a “dead end”. Such traps are not attractive to animals such as rodents which like to have a free run through an obstacle and can be deterred from entering such traps because of the blind nature of the entrance.

Animal traps are routinely checked to identify whether an animal has been trapped, to dispense with any trapped animals, to refresh a supply of bait within the trap and to check that the trap is not malfunctioning or has been triggered accidentally. Although such checks must be made routinely, a substantial period of time may elapse between checks, especially on large sites. If the trap is a humane trap—i.e. intended not to kill the animal upon containment, then there is a risk that the animal may die from starvation or under other stressful conditions a substantial period of time before the trap is due to be checked again. The containment of a dead animal is an invitation to other pests and diseases and comprises a further source of contamination for the surrounding environment. It is necessary, therefore, to check traps very frequently.

The provision of an animal trap which is more readily accessible to animals and which results in a greater capture rate presents related problems in that the traps must, therefore, be checked even more regularly to ensure that any trapped animals are dealt with promptly.

It is an object of the present invention to provide an animal trap system which seeks to overcome the problems associated with conventional animal traps such as those described above.

Accordingly, one aspect of the present invention provides an animal trap comprising a containment body with at least two entrances, each entrance having a door operable to close and contain an animal within the containment body, the entrances to the containment body being aligned so as to provide an animal to be trapped with a view through the containment body.

Preferably, a release mechanism is provided within the containment body to initiate closure of the doors.

Conveniently, the release mechanism is a release mechanism common to all the doors and the doors are operable to close, upon release, simultaneously.

The present invention also provides an animal trap system incorporating an animal trap having a transmitter unit operable to transmit a first signal indicative of the presence of the trap.

Preferably, the transmitter unit is operable to transmit a second signal indicative of the activation of the trap.

Conveniently, the transmitter unit includes an identification code generator to produce an indication code for transmission in the or each signal transmitted by the transmitter unit.

Advantageously, the transmitter unit includes a switch to disable the first signal upon activation of the trap.

Alternatively, the transmitter unit includes a switch to disable the first signal and enable the second signal upon activation of the trap.

Preferably, the transmitter unit is operable to transmit periodically the or each signal.

Conveniently, the period is at least once within a pre-determined time period.

Advantageously, the predetermined time period is in the region of half an hour or less.

Preferably, an indicator unit is provided having a receiver operable to receive signals from the or each transmitter unit, the indicator unit providing an alert signal when a signal is not received from a transmitter unit within a predetermined time period.

Conveniently, an indication of the identity of a transmitter unit which has failed to transmit.

Advantageously, the alert signal provides an indication of the identity of a transmitter unit upon receipt by the indicator unit of a transmission by that transmitter unit of a second signal after receipt of a different first signal.

In order that the present invention may be more readily understood, embodiments thereof will now be described, by way of example, with reference to the accompanying drawings in which:

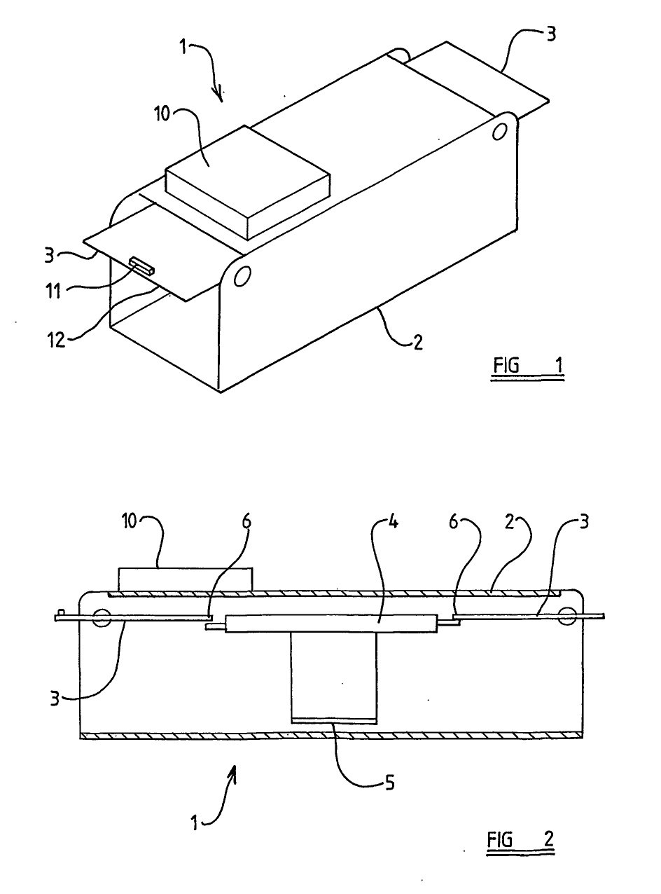

FIG. 1 is a perspective view of an animal trap embodying the present invention;

FIG. 2 is a cross-sectional side view of the animal trap in FIG. 1 in an armed configuration;

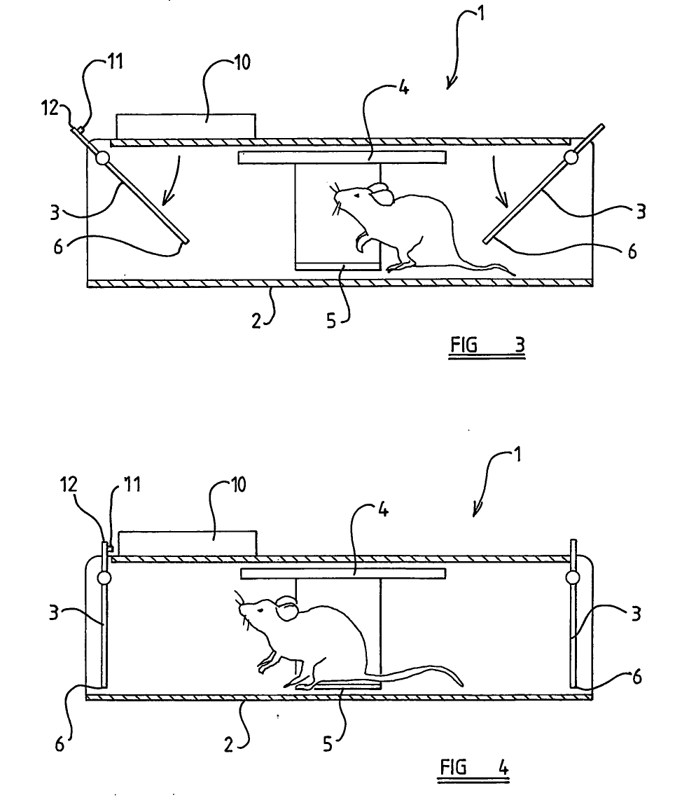

FIG. 3 is a cross-sectional side view of the animal trap of FIG. 1, a rodent having triggered the trap and the doors of the trap being partially closed; and

FIG. 4 is a cross-sectional side view of the animal trap of FIG. 1, the trap being fully closed with a rodent contained inside.

Referring to the Figures, an animal trap 1 embodying the present invention comprises a containment body 2 comprising a substantially rectangular tube, having two entrances at opposite ends of the tube.

The containment body 2 and the doors 3 are preferably manufactured from a durable material resistant to wear and escape attempts by contained animals. A preferred material is sheet metal. The containment body has a hinged door 3 at either end. The doors 3 hinge about the top of each entrance.

A release mechanism 4 and a platform 5 are located within the containment body 2—midway along the length of the containment body 2. As shown in FIG. 2, when the doors 3 are flully hinged open, the bottom edge 6 of each door 3 rests on the release mechanism 4 within the containment body 2. The platform 5 depends from and is mechanically linked to the release mechanism 4 such that any movement of the platform 5 or pressure on the platform 5 is transmitted to the release mechanism and removes the support for the bottom edges 6 of the doors 3 which swing down under gravity to close the entrances thereby enclosing any animal within the containment body 2. Preferably, the hinges of the doors include an over-dead-centre or key-way locking mechanism so that the doors are automatically locked in the vertical position fully closing the containment body as shown in FIG. 4.

Appropriate release mechanisms, hinging mechanisms and locking mechanisms are well known to those of ordinary skill in the art.

To release an animal, one of the doors is unlocked, the unlocking mechanism depending upon the locking mechanism implemented. If the doors are locked by a key-way mechanism, then the door is simply lifted such that a key protruding from the door is removed from a key-way slot into which the key has dropped upon closure of the door and rotated through 90° to the open condition.

Bait can be provided on the platform 5 to entice rodents such as rats or mice into the animal trap 1 and onto or in proximity with the platform 5. The animal trap 1 embodying the present invention is specifically designed such that the animal is also enticed into the containment body 2 by the provision of a view of the environment beyond the trap. Since the animal can see through the trap, the animal is provided with confidence to approach the trap and move through the trap and into or onto the platform 5. Both entrances to the trap are not “blind”. This arrangement significantly increases the effectiveness of the animal trap.

As a consequence of the increased effectiveness of the animal trap, such traps would need to be manually checked more regularly than conventional traps with blind entrances. However, such manual checking is time consuniing and expensive. Another aspect of the present invention therefore provides a simple and non-expensive alerting system for advising when an animal has been caught or when a trap or the system has malfunctioned or been accidentally triggered.

A preferred embodiment of the alerting system comprises a transmitter unit 10 fixed to each of the animal traps 1 and a central indicator unit (not shown) located, for example, in a caretaker's or a security guard's office. The indicator unit incorporates a radio receiver but no transmitter.

The transmitter units 10 are mounted on the animal traps 2 by a pair of electrically conductive lugs (not shown) which protrude from the top surface of the containment body. Corresponding holes are provided in the base of the transmitter unit 10 which registers on the lugs. Preferably, the lugs are provided in an asymmetric arrangement such that the transmitter unit 10 can only be located on the lugs in one orientation.

Each transmitter unit 10 incorporates a power source such as a battery, a transmitter, an identification code generator, a modulator and a switch to alter the state of the modulator or the identification code generator. When the transmitter unit 10 is fixed by the lugs onto the containment body 2 (which is electrically conductive), this completes an electrical circuit activating the transmitter causing the transmitter to send a first signal which is indicative of the presence of a trap. If the containment body is manufactured from an electrically non-conductive material, then a conductive track or wire is connected between the lugs to allow the power circuit of the transmitter unit 10 to be closed. Each transmitter unit 10 has a unique code set by the identification code generator which preferably comprises one or more DIL switches. The settings of the DIL switches determine the identification code. The transmitted signals are modulated by the modulator to include the identification. code for each transmitter unit thereby enabling the identification of a transmitter unit upon receipt of the signal.

When an animal enters a trap 1 and the doors 3 close behind it, a magnetic element 11 mounted on the top edge 12 of the door 3 adjacent the transmitter unit 10 moves into close proximity with the transmitter unit 10 and triggers a reed switch or the like within the transmitter which causes the modulator to change from transmitting the first signal which is indicative of the presence of the trap to transmit a second signal which is indicative that the trap has been activated (whether inadvertently or correctly by trapping an animal). The second signal still contains the identification code thereby allowing identification of the triggered trap.

Each transmitter unit transmits the appropriate first or second signals periodically, preferably on a continuous basis at pseudo-random time intervals so that signals from other transmitter units are unlikely to collide with one another. The maximum time period between transmissions for each transmitter unit is set to be less than approximately half an hour.

The radio receiver in the indicator unit receives radio signals transmitted by the respective transmitter units 10 in the vicinity. The indicator unit issues an error signal if no transmission is received from a particular transmitter unit 10 for a set period of time, for example half an hour. The indicator unit 10 continues to receive the first signals transmitted by the transmitter units 10 and only indicates that a trap 1 has been activated or a rodent caught when a transmitter unit stops transmitting the first signal and starts transmitting the second signal. Preferably, the indicator unit includes a digital display or the like which displays: the identity of the particularly transmitter associated with the trap which has been activated; an error indication; and a trap-activated indication. Thus, by viewing the indicator unit, an operator can determine which trap needs attention and what form of attention is required. The indicator unit also includes an audible warning signal generator to provide an audible warning that attention is required.

It should be appreciated that this simple approach for checking that the animal traps and their transmitters are working correctly removes the need to interrogate individual traps for information and allows the design of the system to be greatly simplified.

By using a combination of the above-described alerting system and an animal trap offering an animal a view of the environment beyond and through the trap a complete animal trap system is provided which operates effectively and which only requires maintenance or attention when an error is detected or an animal has been trapped thereby saving valuable man hours. The simplicity of the system also provides advantages over more complex systems which require interrogation of animal traps or their transmitters by a central transmitter or control unit.

The provision of a transmitter unit 10 which is switchable to issue a first signal whilst the trap is armed and then start transmitting a second signal when the trap has been activated can be simplified further. Rather than switching to transmitting a second signal, the transmitter can be configured simply to stop transmitting on a continuous pseudo-random basis once the trap has been activated. The indicator unit would then be alerted that a particular transmitter is no longer transmitting. Whilst this would provide an indication that the trap has been activated, the switch turning the transmitter off, it could also be an indication that the transmitter has failed or the power source within the transmitter has run out. The disadvantage of this system is that it does not present the operator at the indicator unit with any information as to whether the transmitter has failed or whether the trap has been activated. In any event, the trap would need to be inspected and action taken either to restore the power supply, rearm the trap or deal with a trapped animal.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1-14. (canceled)

15. An animal trap, comprising:
a containment body having at least two entrances, each entrance having a door that closes to contain an animal within said containment body, said entrances aligned so as to provide an animal to be trapped with a view through said containment body;
a release mechanism that initiates simultaneous closure of said doors; and
a transmitter unit that transmits one or more signals.

16. The animal trap of claim 15, further comprising an indicator unit that receives said one or more signals and provides one or more alerts.

17. An animal containment system, comprising:
a containment body having at least two entrances, each entrance having a door that closes to contain an animal within said containment body, said entrances aligned so as to provide an animal to be trapped with a view through said containment body;
a release mechanism that initiates simultaneous closure of said doors; and
a transmitter unit that transmits one or more signals.

18. The containment system of claim 17, further comprising an indicator unit that receives said one or more signals and provides one or more alerts.

19. A method that makes an animal trap, comprising:
providing a containment body having at least two entrances, each entrance having a door that closes to contain an animal within said containment body, said entrances aligned so as to provide an animal to be trapped with a view through said containment body;
coupling a release mechanism to said containment body, said release mechanism initiates simultaneous closure of said doors; and
coupling a transmitter unit to said containment body, said transmitter unit transmits one or more signals.

20. The method of claim 19, further comprising providing an indicator unit that receives said one or more signals and provides one or more alerts.

21. A method that traps an animal, comprising:
providing a containment body having at least two entrances, each entrance having a door that closes to contain an animal within said containment body, said entrances aligned so as to provide an animal to be trapped with a view through said containment body;
closing said doors simultaneously using a release mechanism; and
transmitting one or more signals using a transmitter unit.

22. The method of claim 21, further comprising receiving said one or more signals using an indicator unit that provides one or more alerts.

23. A dependent claim according to claim 15, 17, 19, or 21, wherein said transmitter transmits a first signal when said doors are open that indicates the presence of a set trap.

24. A dependent claim according to claim 23, wherein said transmitter unit transmits a second signal when said doors are closed that indicates that a trap has been activated.

25. A dependent claim according to claim 23, wherein said transmitter unit disables said first signal when said doors are closed.

26. A dependent claim according to claim 24, wherein said transmitter unit disables said first signal and enables said second signal when said doors are closed.

27. A dependent claim according to claim 15, 17, 19, or 21, wherein said transmitter unit transmits a unique identification code that identifies said transmitter unit in said one or more signals.

28. A dependent claim according to claim 15, 17, 19, or 21, wherein said transmitter unit transmits said one or more signals at least once during a pre-determined time period.

29. A dependent claim according to claim 16, 18, 20, or 22, wherein said indicator unit provides said one or more alerts under one or more of the following conditions: when said indicator unit does not receive a signal from said transmitter unit within a predetermined time period, or when said indicator unit receives a first signal from said transmitter unit indicative of the presence of a trap followed within a predetermined time period by a second signal indicative of the closure of said doors.

30. A dependent claim according to claim 29, wherein said transmitter unit transmits a unique identification code that identifies said transmitter unit in said one or more signals and said one or more alerts further indicates the identity of said transmitter unit.
